(19) United States
(12) Patent Application Publication
(10) Pub. No.: US 2025/0273714 A1
(43) Pub. Date: Aug. 28, 2025

(54) FUEL CELL SYSTEM HYDROGEN TANK LEAK DETECTION

(71) Applicant: FORD GLOBAL TECHNOLOGIES, LLC, Dearborn, MI (US)

(72) Inventors: Michiel J. VAN NIEUWSTADT, Ann Arbor, MI (US); Ross Dykstra PURSIFULL, Dearborn, MI (US)

(21) Appl. No.: 18/584,356

(22) Filed: Feb. 22, 2024

(51) Int. Cl. H01M 8/04746; H01M 8/04082; H01M 8/0438; H01M 8/0444; H01M 8/2484

(52) U.S. Cl. CPC H01M 8/04753; H01M 8/04201; H01M 8/04388; H01M 8/04447; H01M 8/2484; H01M 2250/20

(57) ABSTRACT

After a value of a thermodynamic property of fuel in a manifold remains same, while each of a plurality of fuel tanks is sequentially fluidly coupled to the manifold, and less than the value during previous operation of a stack, a controller prevents at least one of the fuel tanks from providing fuel to the stack during subsequent operation of the stack.

### STATEMENT REGARDING FEDERALLY SPONSORED RESEARCH OR DEVELOPMENT

The invention was made with Government support under Contract No. DE-EE0009858 awarded by the Department of Energy. The Government has certain rights to the invention.

### TECHNICAL FIELD

The present disclosure generally relates to a system for detecting fuel storage leak of a vehicle. More specifically, the present disclosure relates to a system for detecting a hydrogen tank leak of a fuel cell vehicle.

### BACKGROUND

Fuel cell vehicles rely on gaseous fuel such as hydrogen to provide energy for propulsion. The fuel may be stored in one or more pressurized fuel tanks connected to a fuel line controlled by valves. The vehicles may monitor the operating status of the fuel line and tanks via one or more pressure sensors or density sensors.

### SUMMARY

A vehicle comprises a fuel cell system including a stack, a plurality of fuel tanks configured to store pressurized fuel for the stack, a manifold, and a plurality of tank valves each connected between one of the fuel tanks and the manifold. The vehicle also comprises a controller that, responsive to an increase in a value of a thermodynamic property of fuel in the manifold that occurs while sequentially fluidly coupling each of the fuel tanks to the manifold via at least one of the tank valves during a vehicle parked condition, prevents at least one of the fuel tanks from providing fuel to the stack during subsequent operation of the vehicle.

A method comprises, after an increase in mass of fuel in a manifold of a fuel cell system for a vehicle that occurs while sequentially fluidly coupling each of a plurality of fuel tanks of the fuel cell system to the manifold during a parked condition of the vehicle, preventing at least one of the fuel tanks from providing fuel to a stack of the fuel cell system during subsequent operation of the vehicle.

An automotive fuel cell system comprises a stack, a plurality of fuel tanks that store pressurized fuel for the stack, a manifold, and a controller. The controller, after a value of a thermodynamic property of fuel in the manifold remains same while each of the fuel tanks is sequentially fluidly coupled to the manifold and less than the value during previous operation of the stack, prevents at least one of the fuel tanks from providing fuel to the stack during subsequent operation of the stack.

### BRIEF DESCRIPTION OF THE DRAWINGS

FIG. 1 illustrates an example block diagram fuel cell electric vehicle having a fuel cell system and a traction battery.

FIG. 2 illustrates an example schematic diagram of the fuel supply system of the fuel cell electric vehicle.

FIGS. 3A and 3B illustrate example timing graphs of fuel density in the high-pressure manifold.

FIG. 4 illustrates an example flow diagram of a process for detecting fuel tank leaks and performing mitigation operations.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for detecting a fuel tank leak of a vehicle. More specifically, the present disclosure proposes a system and method for detecting a fuel tank leak of a vehicle having a plurality of pressurized fuel tanks.

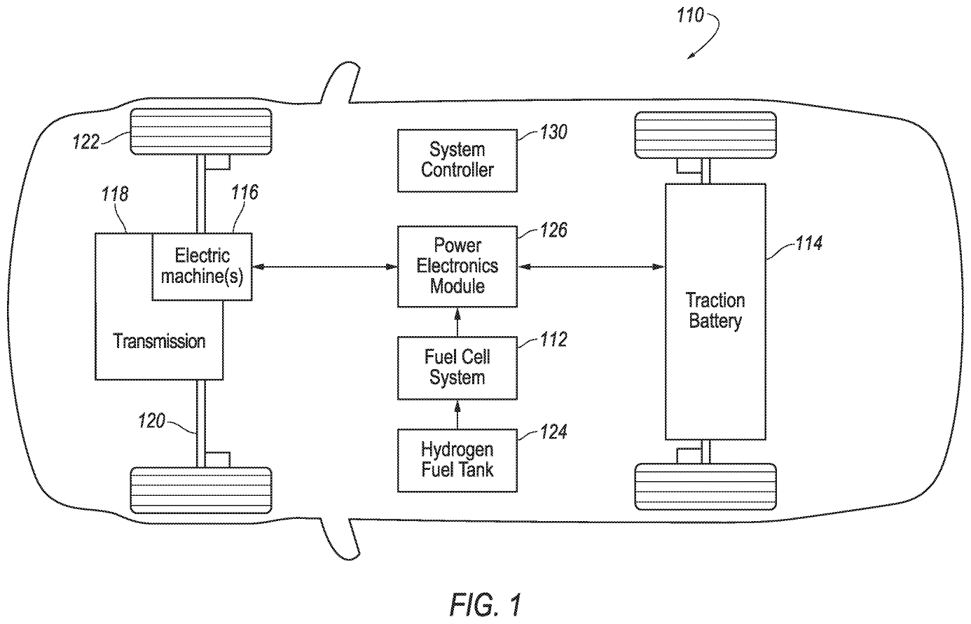

Referring now to FIG. 1, a block diagram of an exemplary fuel cell electric vehicle (FCEV) 110 having a fuel cell system 112 and a traction battery 114 is illustrated. The fuel cell system 112 and the traction battery 114 are individually operable for providing electrical energy for propulsion of the FCEV 110.

The fuel cell system 112 includes one or more fuel cell stacks (not shown). Each fuel cell stack may include a plurality of fuel cells electrically connected in series. For simplicity, the fuel cell system 112 is described herein as having one fuel cell stack although the present disclosure is not limited thereto. The fuel cell system 112 further includes auxiliary equipment such as an electric compressor for the fuel cell system air supply.

The FCEV 110 may further include one or more electric machines 116 mechanically connected to a transmission 118. The electric machine 116 may be capable of operating as a motor and as a generator. The transmission 118 is mechanically connected to a drive shaft 120 mechanically connected to wheels 122 of the FCEV 110. The electric machine 116 may provide propulsion and slowing capability for the FCEV 110. The electric machine 116 acting as a generator may recover energy that may normally be lost as heat in a friction braking system. The energy recovered by the electric machine 116 may be used to recharge the traction battery 114.

The fuel cell system 112 may be configured to convert hydrogen from one or more hydrogen fuel tanks 124 of the FCEV 110 into electrical energy. The electrical energy from the fuel cell system 112 may be used by the electric machine 116 for propelling the FCEV 110 and/or for recharging the traction battery 114. The fuel cell system 112 may be electrically connected to the electric machine 116 via a power electronics module 126 of the FCEV 110. The power electronics module 126, having an inverter or the like, may provide the ability to transfer electrical energy from the fuel cell system 112 to the electric machine 116. For example, the fuel cell system 112 may provide direct current (DC) electrical energy while the electric machine 116 may require three-phase alternating current (AC) electrical energy to function. The power electronics module 126 may convert the electrical energy from the fuel cell system 112 into electrical energy having a form compatible for operating the electric machine 116. In this way, the FCEV 110 may be configured to be propelled with use of electrical energy from the fuel cell system 112.

The battery 114 may store electrical energy for use by the electric machine 116 for propelling the FCEV 110. The battery 114 may be also electrically connected to the electric machine 116 via the power electronics module 126. The power electronics module 126 may provide the ability to bi-directionally transfer electrical energy between the battery 114 and the electric machine 116. For example, the battery 114 may also provide DC electrical energy while the electric machine 116 may require the three-phase AC electrical energy to function. The power electronics module 126 may convert the electrical energy from the battery 114 into electrical energy having a form compatible for operating the electric machine 116. In this way, the FCEV 110 may be further configured to be propelled with the use of the battery 114 individually or in combination with the fuel cell system 112. Further, in a regenerative mode, the power electronics module 126 may convert AC electrical energy from the electric machine 116 acting as a generator to DC electrical energy compatible with the battery 114.

The fuel cell system 112 and the battery 114 may have one or more associated controllers to control and monitor the operation thereof. The controllers may be microprocessor-based devices. The controllers may communicate via a serial bus (e.g., Controller Area Network (CAN)) or via discrete conductors.

For example, a system controller 130 (i.e., a vehicle controller) may be configured to coordinate the operation of the fuel cell system 112 and the battery 114. The system controller 130 may be further configured to control the fuel cell system 112 and the battery 114 accordingly. In operation for propelling the FCEV 110, the system controller 130 may interpret and split a driver power demand into a fuel cell system power request and a battery power request. In turn, the fuel cell system 112 may be controlled to output electrical power corresponding to the fuel cell system power request to the electric machine 116 for use in propelling the FCEV 110. Likewise, the battery 114 may be controlled to output electrical power corresponding to the battery power request to the electric machine 116 for use in propelling the FCEV 110. It is noted that the term system controller 130 is used as a general term in the present disclosure and may be implemented as one or more controllers, processors or any device having data processing and communication capabilities to operate and control various operations of the FCEV 110.

As noted above, the fuel cell system 112 may include a fuel cell stack including a series connection of a plurality of fuel cells. The voltage of each of the fuel cells may depend on various factors including cell temperature, membrane humidity, pressure, anode hydrogen amount, air flow rate, current or the like. As an example, the voltage of one of the fuel cells may be most sensitive and responsive to the current of the fuel cell.

As the fuel cells of a fuel cell stack are connected in series, the voltage of the fuel cell stack may be a summation of all the voltages of the fuel cells of the fuel cell stack. Likewise, as the fuel cells of the fuel cell stack are connected in series, each fuel cell may have the same current, and the current of the fuel cell stack may be the same as the current of each of the fuel cells. The power delivered by the fuel cell stack may be equal to the stack voltage multiplied by the stack current.

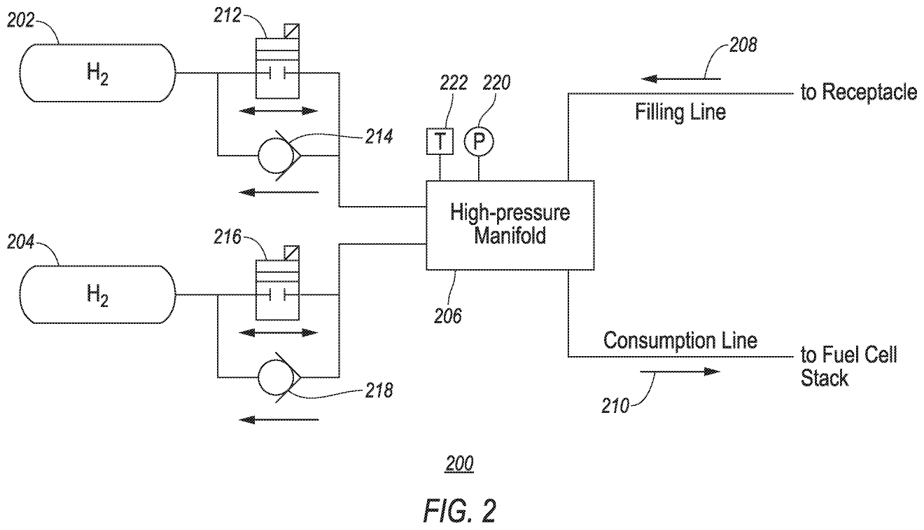

Referring to FIG. 2, a schematic diagram of the fuel supply system 200 of the FCEV of one embodiment of the present disclosure is illustrated. With continuing reference to FIG. 1, the FCEV 110 in the present example is provided with two on-board hydrogen fuel tanks to supply fuel to the fuel stack. More specifically, the fuel supply system 200 includes a first fuel tank 202 and a second fuel tank 204 configured to independently store hydrogen fuel. It is noted that although the fuel supply system 200 includes only two fuel tanks, the present disclosure is not limited thereto. The system structure and process described in the present disclosure may be applied to FCEVs with more than two fuel tanks under essentially the same principle.

The fuel supply system 200 may be a pressurized system isolated from the outer atmosphere. Thus, the fuel supply system 200 may be provided with a high-pressure manifold 206 configured to connect the fuel tanks 202, 204 with various components of the FCEV 110. For instance, the high-pressure manifold 206 may be connected to a fuel filling receptacle via a filling line 208 configured to receive fuel refuels and supply to the fuel tanks 202, 204. The high-pressure manifold 206 may be further connected to the fuel cell stack (or injectors) via a fuel consumption line 210 to supply hydrogen fuel from the tank for consumption.

As illustrated in FIG. 2, the fuel tanks 202, 204 may be connected to the high-pressure manifold via one or more valves. More specifically, the first fuel tank 202 may be connected to the high-pressure manifold 206 via a first tank valve 212. The first tank valve 212 may be actuated via solenoid controlled by one or more controllers such as the system controller 130. When the first tank valve 212 is open as controlled by the system controller 130, the first fuel tank 202 may be connected to the high-pressure manifold 206 and the pressure between the first fuel tank 202 and the high-pressure manifold may equalize. When the first tank valve 212 is closed as controlled by the system controller 130, the first fuel tank 202 may be separated from the high-pressure manifold 206.

In parallel to the first tank valve 212, the first fuel tank 202 may be further connected to the high-pressure manifold 206 via a first check valve 214 configured to allow one-way fuel flow from the high-pressure manifold 206 to the first fuel tank 202 for refilling. For instance, the first check valve 214 may be a spring-loaded ball check valve having a spring pushing a ball from the tank side to the manifold side closing the first check valve 214 by default. When the FCEV 110 is refilled, a fuel nozzle may be connected to the fuel receptacle to supply fuel via the high-pressure manifold 206. The increased pressure at the high-pressure manifold 206 may overcome the spring tension and push the first check valve 214 open such that the fuel may flow to the first fuel tank 202 via the first check valve 214 without requiring the first tank valve 212 to open. When the refilling completes and the fuel nozzle is removed, the pressure on the tank side and the manifold size may equalize and the first check valve 214 may close by the spring tension.

Similarly, the second fuel tank 204 may be connected to the high-pressure manifold 206 via a second tank valve 216 controlled by the system controller 130. The second fuel tank 204 may be further connected to the high-pressure manifold 206 via a second check valve 218 for refilling purposes. The operations of the second tank valve 216 and the second check valve 218 are like the operations of the first tank valve 212 and the first check valve 214 and therefore will not be repeated herein for simplicity.

The fuel supply system 200 may be provided with various sensors configured to monitor the operation conditions of the FCEV 110. In the present example, the fuel supply system 200 may be provided with a pressure sensor configured to measure the fuel pressure inside the high-pressure manifold 206. The fuel supply system 200 may be further provided with a temperature sensor configured to measure a fuel temperature of the high-pressure manifold 206. Although both the pressure sensor 220 and the temperature sensor 222 are directly associated with the high-pressure manifold in the present example as illustrated in FIG. 2, the present disclosure is not limited thereto. The fuel supply system 200 may be provided with a plurality of pressure sensors and temperature sensors placed at various locations for measurements. For instance, each fuel tank 202, 204 may be provided with a temperature sensor (not shown) configured to measure the fuel temperature inside the respective fuel tanks 202, 204. Each of the fuel tanks 202, 204 may be provided with an inlet temperature sensor located between the fuel tank 202, 204 and the respective tank valve 212, 216 to measure the fuel temperature supplied from the tank. Each of the filling line 208 and consumption line 210 may be provided with one or more pressure sensors (not shown) for fuel pressure measurements.

In general, it is a common practice in the FCEV industry to not directly place any pressure sensors inside the pressurized fuel tank. Therefore, the fuel pressure inside each tank may not be directly measurable. The present disclosure proposes a system for detecting a fuel tank leak based on the fuel pressure inside the high-pressure manifold without requiring a direct measurement of the fuel pressure within the leaking tank. More specifically, the present disclose proposes a method for determining a fuel tank leak by sequentially connecting different fuel tanks to the high-pressure manifold and monitoring the fuel density variation pattern at different timing points inside the high-pressure manifold.

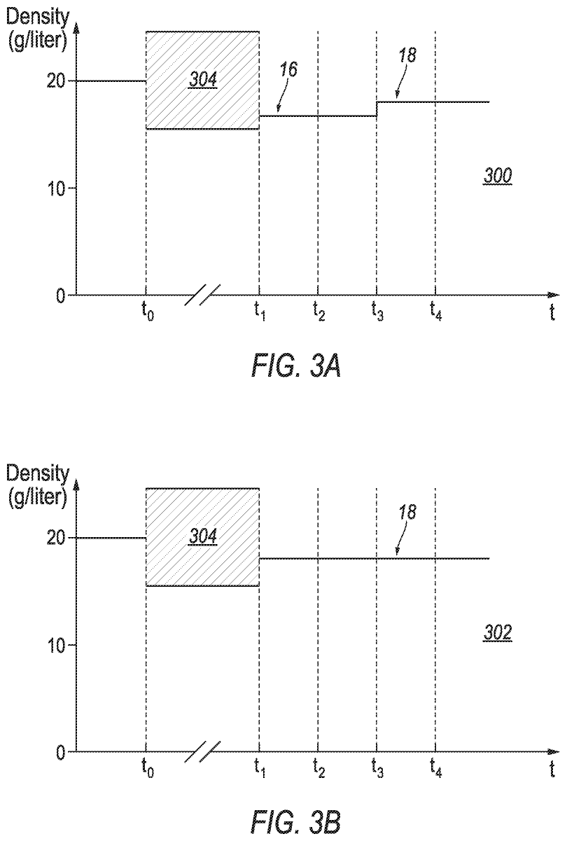

Referring to FIGS. 3A and 3B, timing graphs 300, 302 of one example of the present disclosure is illustrated. In the present example, it is assumed that the FCEV 110 is provided with two fuel tanks 202, 204 and only the second fuel tank 204 is leaking and losing fuel when the FCEV 110 is parked. More specifically, at t0 when the FCEV 110 is parked, both of the tank valves 212, 216 are closed isolating the fuel tanks 202, 204 from the high-pressure manifold 206. At t1, the FCEV 110 starts and the system controller 130 connects one of the fuel tanks 202, 204 to the high-pressure manifold 206. While FIG. 3A illustrates the example in which the leaking second fuel tank 204 is first connected to the high-pressure manifold 206 at t1, FIG. 3B illustrates the example in which the non-leaking first fuel tank 202 is first connected to the high-pressure manifold 206 at t1. The horizontal axis of the timing graphs 300, 302 denotes the time elapsed, and the vertical axis denotes the fuel density (e.g., in units of grams per liter) inside the high-pressure manifold 206. Compared with directly using the fuel pressure, the fuel density is preferred because the fuel density also takes the fuel temperature into account which provides a more accurate measurement of the fuel supply system 200. Thus, the fuel density may be determined as a function of fuel pressure and fuel temperature. As known in the art, temperature, pressure, density, etc. are thermodynamic properties. Alternatively, a fuel mass may be utilized in addition to or in lieu of the fuel density or fuel pressure under essentially the same concept.

Referring to the timing graphs 300 illustrated in FIG. 3A, before to when the FCEV 110 is in use, both the first and second fuel tanks 202, 204 are connected to the high-pressure manifold 206. Therefore, the fuel density inside the high-pressure manifold 206 is equal to the fuel density inside both of the tanks 202, 204. In the present example, the fuel density is approximately 20 g/liter. At t0, both of the tank valves 212, 216 are closed and the fuel tanks 202, 204 are isolated from the high-pressure manifold 206. The fuel density inside the high-pressure manifold 206 may vary significantly during parking due to various factors. For instance, the fuel pressure may be affected by the ambient temperature where the FCEV 110 is parked. For example, if the FCEV 110 is parked directly in sunlight, the fuel pressure may increase due to the increased temperature. Since the high-pressure manifold 206 is relatively small in capacity compared with the fuel tanks 202, 204, the fuel density in the high-pressure manifold 206 may be affected by a more significant magnitude compared with the fuel stored in the fuel tanks 202, 204. For instance, while factors such as temperature may only moderately affect the fuel pressure inside the fuel tanks 202, 204 (e.g., +−10 bar), the same factors may significantly affect the fuel density inside the high-pressure manifold 206 (e.g., +/−20 bar). Therefore, as illustrated in FIG. 3A, the fuel density inside the high-pressure manifold may be within a density range 304 when the FCEV 110 is parked from t0 until t1.

At t1 as the FCEV 110 starts, the second tank valve 216 opens and connects the second fuel tank 204 to the high-pressure manifold 206 while the first tank valve 212 remains closed. Therefore, the fuel density inside the high-pressure manifold equalizes with the fuel density inside the second fuel tank 204 at t1. In the present example, the fuel density of the second fuel tank 204 reduces from 20 g/liter at t0 to approximately 16 g/liter at t1 due to the leak, and therefore, the fuel density inside the high-pressure manifold may be measured as 16 g/liter. Since the fuel density inside the high-pressure manifold 206 (e.g., 16 g/liter) is less than the fuel density inside the non-leaking first fuel tank 202 (e.g., remaining at 20 g/liter), the first check valve 214 may not open. Therefore, the fuel density inside the high-pressure manifold 206 remains equal to that inside the second fuel tank 204 and unaffected by the first fuel tank 202. The system controller 130 may record the fuel density inside the high-pressure manifold 206 for future comparison.

At t2, the system controller 130 closes the second check valve 216 to isolate the second fuel tank 204 from the high-pressure manifold 206. Since the fuel density has stabilized between t1 and t2, the fuel density inside the high-pressure manifold 206 remains unchanged at t2.

At t3, when the system controller 130 opens the first tank valve 212 and connects the first fuel tank 202 to the high-pressure manifold 206, the fuel having higher density inside the first tank 202 may flow to the high-pressure manifold 206 increasing the fuel density inside. In the present example, the fuel density inside the high-pressure manifold 206 may increase from 16 g/liter to 18 g/liter. The system controller 130 may compare the increase in fuel density with the first fuel density monitored at t1, and determine the first sequentially connected fuel tank (i.e., the second fuel tank 204) is leaking responsive detecting the increased fuel density pattern.

However, the fuel density pattern may not be the same if the fuel tanks 202, 204 are connected to the high-pressure manifold 206 in reverse order. Referring to FIG. 3B, an example with the reversed order (e.g., the non-leaking first fuel tank first, and the leaking second fuel tank second) is illustrated. Like the example illustrated with reference to FIG. 3A, the FCEV 110 parks at t0 and the fuel density inside the high-pressure manifold 206 may vary within the range 304 before t1 when the first tank valve 212 is opened to connect the first fuel tank 202 with the high-pressure manifold 206. At t1, the first fuel tank 202 at approximately 20 g/liter fuel density is connected to the high-pressure manifold 206. Although the second tank valve 216 remains closed, the second check valve 218 may be opened by the higher fuel density (e.g., 20 g/liter) on the high-pressure manifold side compared with the lower fuel density (e.g., 16 g/liter) on the second fuel tank side due to the fuel leak. Therefore, after opening the first tank valve 212 at t1, the fuel density inside the high-pressure manifold 206 may gradually equalize and stabilize at somewhere between the density of the first and second fuel tanks 202, 204, e.g., 18 g/liter in the present example. The second check valve 218 closes once the fuel pressure on the two sides is equalized.

At t2, the system controller 130 closes the first check valve 212 to isolate the first fuel tank 202 from the high-pressure manifold 206. Since the fuel density has stabilized between t1 and t2, the fuel density inside the high-pressure manifold 206 remains unchanged at t2.

At t3, the system controller 130 opens the second check valve 216 and connects the second fuel tank 204 with the high-pressure manifold 206. Since the fuel density between the high-pressure manifold 206 and the second tank 204 has already been equalized via the second check valve 218, the measured fuel density in the high-pressure manifold may not change at t3. In contrast to the example illustrated with reference to FIG. 3A, the lack of a fuel density increase at t3 in the present example may indicate the first sequentially connected fuel tank (i.e., the first tank 202) is not leaking.

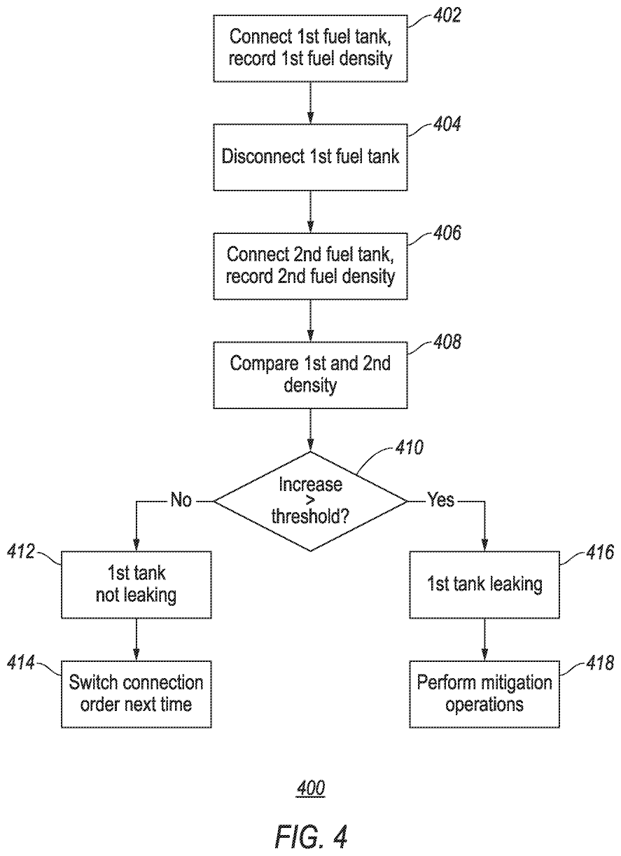

Referring to FIG. 4, a flow diagram of a process 400 for detecting a fuel tank leak and performing mitigation operations of one embodiment of the present disclosure is illustrated. With continuing reference to FIGS. 1-3, the process 400 may be performed by various components of the FCEV 110. For simplicity, the following description will be made with reference to the system controller 130.

At operation 402, the system controller 130 connects the first fuel tank 202 to the high-pressure manifold 206 by opening the first tank valve 212 and records a first fuel density inside the high-pressure manifold 206. At operation 404, the system controller 130 disconnects the first fuel tank 202 from the high-pressure manifold 206 by closing the first tank valve 212 after the stabilized first fuel density has been recorded.

At operation 406, the system controller 130 connects the second fuel tank 204 to the high-pressure manifold 206 by opening the second tank valve 216 and records a second fuel density inside the high-pressure manifold 206.

At operation 408, the system controller 130 compares the second fuel density with the first fuel density to determine if there is an increase in fuel density. If the system controller 130 detects that an increase does not exist or the increase is less than a predefined threshold (e.g., 2 g/liter), the process proceeds from operation 410 to operation 412 and the system controller 130 determines the first fuel tank 202 is not leaking. At operation 414, the system controller switches the connecting order the next time when the vehicle is started. For instance, since the first fuel tank 202 is connected to the high-pressure manifold first in the present process 400, the second fuel tank will be connected first the next time when FCEV 110 starts from parking.

Otherwise, if at operation 410 the system 130 detects the increase exists and is greater than the predefined threshold, the process proceeds to operation 416 and the system controller 130 determines the first fuel tank 202 is leaking.

In response, at operation 418, the system controller 130 performs mitigation operations to address this issue. The mitigation operations may include various examples. For instance, the system controller 130 may output a message via a vehicle interface to inform the vehicle user about the detected fuel tank leak. The system controller 130 may close the first tank valve 212 such that the leaking first tank 202 is isolated from the rest of the fuel supply system 200. In some cases, the first check valve 214 may be disabled such that the fuel does not back flow from the high-pressure manifold to the first tank as the tank pressure reduces over time due to the leak. The FCEV 110 may be provided with one or more onboard pumps (not shown) configured to transfer and balance fuel between each tank. In this case, the system controller 130 may transfer the fuel away from the leaking first tank 202 to the non-leaking second tank 204 to preserve fuel.

It is noted that although the process 400 is described with reference to a two-tank design FCEV, the present disclosure is not limited thereto and the process 400 may be applied to FCEVs having more than two fuel tanks under essentially the same concept.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words controller and controllers, for example, may be used interchangeably herein.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a fuel cell system including a stack, a plurality of fuel tanks configured to store pressurized fuel for the stack, a manifold, and a plurality of tank valves each connected between one of the fuel tanks and the manifold; and
a controller programmed to, responsive to an increase in a value of a thermodynamic property of fuel in the manifold that occurs while sequentially fluidly coupling each of the fuel tanks to the manifold via at least one of the tank valves during a vehicle parked condition, prevent at least one of the fuel tanks from providing fuel to the stack during subsequent operation of the vehicle.

2. The vehicle of claim 1 further comprising a plurality of check valves each connected between one of the fuel tanks and the manifold in parallel with one of the tank valves and configured to permit flow of fuel from the manifold to the one of the fuel tanks responsive to the value in the manifold exceeding a value of a thermodynamic property in the one of the fuel tanks.

3. The vehicle of claim 2, wherein the controller is further programmed to, responsive to the value in the manifold remaining same during the sequentially fluidly coupling and less than the value in the manifold during previous vehicle operation, prevent at least one of the fuel tanks from providing fuel to the stack during subsequent operation of the vehicle.

4. The vehicle of claim 1, wherein the controller is further programmed to pump fuel from the at least one of the fuel tanks to other of the fuel tanks.

5. The vehicle of claim 1, wherein the controller is further programmed to generate a message for output regarding the at least one of the fuel tanks.

6. The vehicle of claim 1, wherein the thermodynamic property is density.

7. The vehicle of claim 1, wherein the thermodynamic property is pressure.

8. The vehicle of claim 1, wherein the thermodynamic property is mass.

9. A method comprising:
after an increase in mass of fuel in a manifold of a fuel cell system for a vehicle that occurs while sequentially fluidly coupling each of a plurality of fuel tanks of the fuel cell system to the manifold during a parked condition of the vehicle, preventing at least one of the fuel tanks from providing fuel to a stack of the fuel cell system during subsequent operation of the vehicle.

10. The method of claim 9 further comprising after the mass remaining same during the sequentially fluidly coupling and less than the mass during previous operation of the vehicle, preventing at least one of the fuel tanks from providing fuel to the stack during subsequent operation of the vehicle.

11. The method of claim 9 further comprising pumping fuel from that at least one of the fuel tanks to other of the fuel tanks.

12. The method of claim 9 further comprising generating a message for output regarding the at least one of the fuel tanks.

13. An automotive fuel cell system comprising:
a stack;
a plurality of fuel tanks configured to store pressurized fuel for the stack;
a manifold; and
a controller programmed to prevent at least one of the fuel tanks from providing fuel to the stack during subsequent operation of the stack after a value of a thermodynamic property of fuel in the manifold remains same, while each of the fuel tanks is sequentially fluidly coupled to the manifold, and less than the value during previous operation of the stack.

14. The automotive fuel cell system of claim 13, wherein the controller is further programmed to, after the value increases while each of the fuel tanks is sequentially fluidly coupled to the manifold, prevent at least one of the fuel tanks from providing fuel to the stack during subsequent operation of the stack.

15. The automotive fuel cell system of claim 13, wherein the controller is further programmed to pump fuel from the at least one of the fuel tanks to other of the fuel tanks.

16. The automotive fuel cell system of claim 13, wherein the controller is further programmed to generate a message for output regarding the at least one of the fuel tanks.

17. The automotive fuel cell system of claim 13, wherein the thermodynamic property is density.

18. The automotive fuel cell system of claim 13, wherein the thermodynamic property is pressure.

19. The automotive fuel cell system of claim 13, wherein the thermodynamic property is mass.
